(19) United States
(12) Patent Application Publication
(10) Pub. No.: US 2015/0188139 A1
(43) Pub. Date: Jul. 2, 2015

(54) Positive Electrode Active Material for Lithium Secondary Batteries, Positive Electrode for Lithium Secondary Batteries Using Same, Lithium Secondary Battery, and Method for Producing Positive Electrode Active Material for Lithium Secondary Batteries

(71) Applicant: Hitachi Metals, Ltd., Tokyo (JP)

(72) Inventors: Kan Kitagawa, Tokyo (JP); Shuichi Takano, Tokyo (JP); Toyotaka Yuasa, Tokyo (JP); Shin Takahashi, Tokyo (JP); Takashi Nakabayashi, Tokyo (JP); Mitsuru Kobayashi, Tokyo (JP)

(21) Appl. No.: 14/416,394

(22) PCT Filed: Jul. 25, 2013
(86) PCT No.: PCT/JP2013/070251

§ 371 Date: Jan. 22, 2015

(30) Foreign Application Priority Data
Jul. 25, 2012 (JP) 2012-164802
Jan. 28, 2013 (JP) 2013-013285

(51) Int. Cl. H01M 4/58; H01M 4/62; H01M 4/36; H01M 10/052

(52) U.S. Cl. CPC H01M 4/5825; H01M 10/052; H01M 4/625; H01M 4/364

(57) ABSTRACT

Provided is a positive electrode active material for lithium secondary batteries, which uses a highly safe polyanion compound and has high capacity, high rate characteristics and high energy density. A positive electrode active material for lithium secondary batteries, which contains polyanion compound particles coated with carbon. This positive electrode active material for lithium secondary batteries is characterized in that: the polyanion compound has a structure represented by chemical formula (1); the roughness factor of the polyanion compound, said roughness factor being represented by formula (1), is 1-2; and the average primary particle diameter of the polyanion compound is 10-150 nm. LixMAyOz (chemical formula (1)) (In chemical formula (1), M comprises at least one transition metal element; A represents a typical element that combines with oxygen (O) and forms an anion; 0<x≦2, 1≦y≦2 and 3≦z≦7.)

### TECHNICAL FIELD

The present invention relates to a positive electrode active material for lithium secondary batteries, a positive electrode for lithium secondary batteries and a lithium secondary battery using the same, and a method for producing a positive electrode active material for lithium secondary batteries.

### BACKGROUND ART

For a positive electrode active material for lithium secondary batteries, lithium cobalt oxide is used in most cases conventionally, and a lithium secondary battery using the same is widely used. However, since cobalt, which is a raw material of lithium cobalt oxide, has a small yield and is expensive, an alternative material is studied. For the alternative material of lithium cobalt oxide, spinel-structured lithium manganese oxide and lithium nickel oxide are studied. However, lithium manganese oxide has a problem in that the discharge capacity is not enough and manganese is eluted at high temperatures. Moreover, although lithium nickel oxide is expected to provide a high capacity, thermal stability is not sufficient at high temperatures.

From the viewpoint of thermal stability, a polyanion compound is excellent, which has polyanion (an anion that a plurality of oxygens is bonded to a single main group element such as PO₄³⁻, BO₃³⁻, and SiO₄⁴) in a crystal structure, and is expected as a positive electrode active material for lithium secondary batteries. This is because polyanion bonds (such as a P—O bond, a B—O bond, and an Si—O bond) are strong, and oxygens are not desorbed at high temperatures.

However, the polyanion compound has problems in that electron conduction and ion conduction are low and it is not enabled to provide a sufficient discharge capacity. This is because electrons are localized on the strong polyanion bonds.

To the problems of the polyanion compound described above, Patent Literature 1, for example, proposes a technique in which the surface of a polyanion compound is covered with carbon and electron conduction is improved. Moreover, Non-Patent Literature 1 proposes a technique in which the particle diameter of a polyanion compound is decreased to increase a reaction area, the diffusion length is shortened, and electron conduction and ion conduction are improved.

### CITATION LIST

### Patent Literature

Patent Literature 1: Japanese Patent Application Laid-Open Publication No. 2001-015111

### Nonpatent Literature

Nonpatent Literature 1: A. Yamada, S. C. Chung, and K. Hinokuma, “Optimized LiFePO4 for Lithium Battery Cathodes”, Journal of the Electrochemical Society 148 (2001), pp. A224-A229

### SUMMARY OF INVENTION

### Technical Problem

For the method for covering the polyanion compound with carbon, there are methods including a method in which the compound is mixed with acetylene black or graphite and they are brought into intimate contact with each other using a ball mill, for example, and a method in which the compound is mixed with an organic substance such as sugar, an organic acid, and pitch and baked. Moreover, for a method for decreasing the particle diameter of the polyanion compound, there are a method for decreasing the calcining temperature of the compound, a method for mixing the compound with a carbon source to suppress crystal growth, or the like.

However, any of the methods described above are likely to degrade the crystallizability of the polyanion compound. The degradation of the crystallizability of the positive electrode active material leads to the degradation of the discharge capacity and the rate characteristic.

Therefore, it is an object of the present invention to provide a positive electrode active material for lithium secondary batteries having a high thermal stability at high temperatures, a high discharge capacity, and a high rate characteristic. Moreover, it is another object of the present invention to provide a method for producing the positive electrode active material, and a positive electrode for lithium secondary batteries and a lithium secondary battery produced using the same.

### Solution to Problem

In order to solve the problems, the present invention is a positive electrode active material for lithium secondary batteries including a polyanion compound particle coated with carbon. In the positive electrode active material, the polyanion compound has a structure expressed by chemical formula 1 below; a roughness factor of the polyanion compound expressed by equation 1 below is in a range of 1 to 2; and an average primary particle diameter of the polyanion compound is in a range of 10 to 150 nm.

LixMAyOz (chemical formula 1)

(Where M includes at least one kind of transition metallic elements, A is a main group element that is bonded to oxygen O and forms an anion, 0<x≦2, 1≦y≦2, and 3≦z≦7.)

[Equation 1]

Roughness factor=Specific surface area (a) measured using a BET method/Specific surface area (b) calculated from the average primary particle diameter, supposing that the primary particle is spherical (Equation 1)

Metal M included in chemical formula 1 includes a transition metallic element such as Fe, Mn, Ni, and Co as an essential ingredient. Moreover, a part of a main group element may be included as another component.

Moreover, another aspect of the present invention is a method for producing a positive electrode active material for lithium secondary batteries having a polyanion compound, particularly an olivine structure. The method including the steps of: mixing raw materials including a transition metal compound to be a metal source and a phosphorus compound; pre-calcining the mixed raw materials; mixing a pre-calcined body with a carbon source; and main calcining. In the method, a pre-calcining temperature is a crystallization temperature of the positive electrode active material or greater and a temperature that the crystallization temperature is added with a temperature of 200° C. or less.

Furthermore, the present invention is to provide a method for producing a positive electrode active material for lithium secondary batteries, and a positive electrode for lithium secondary batteries and a lithium secondary battery produced using the positive electrode active material for lithium secondary batteries.

### Advantageous Effects of Invention

According to the present invention, it is possible to provide a positive electrode active material for lithium secondary batteries that a highly safe polyanion compound is used as a positive electrode active material for lithium secondary batteries and a discharge capacity and a rate characteristic are higher than those of a lithium secondary battery using a previously existing polyanion positive electrode active material. Moreover, it is possible to provide a method for producing a positive electrode active material for lithium secondary batteries, and a positive electrode for lithium secondary batteries and a lithium secondary battery that safety and battery performance are combined.

### BRIEF DESCRIPTION OF DRAWINGS

FIG. 1 is a schematic diagram of a half cross section of an exemplary lithium secondary battery to which the present invention is applied.

FIG. 2A is an appearance photograph (an SEM observation image) prior to a carbon coating removal process of a positive electrode active material for lithium secondary batteries according to the present invention.

FIG. 2B is an appearance photograph (an SEM observation image) after the carbon coating removal process in FIG. 2A.

FIG. 3A is an appearance photograph (an SEM observation image) of positive electrode active material powder according to example 1-1.

FIG. 3B is an appearance photograph (an SEM observation image) of positive electrode active material powder according to example 1-2.

FIG. 3C is an appearance photograph (an SEM observation image) of positive electrode active material powder according to comparative example 1-1.

FIG. 3D is an appearance photograph (an SEM observation image) of positive electrode active material powder according to comparative example 1-2.

FIG. 4 is an SEM photograph of a positive electrode active material formed into spherical secondary particles by a method according to the present invention.

FIG. 5 is a diagram of a producing flow of a positive electrode active material according to the present invention.

### DESCRIPTION OF EMBODIMENT

In these years, there is increasing demand for the improvement of the safety and battery performance of lithium secondary batteries (for example, a capacity, a rate characteristic, energy density, and the like). However, as described above, there was a problem in that when the polyanion compound is used to aim for the improvement of safety, it is not enabled to sufficiently satisfy the demanded characteristics from the viewpoint of the battery performance of lithium secondary batteries. In other words, it was strongly demanded for further improvement on these points. The inventors found that to achieve a predetermined surface roughness greatly affects the improvement of the performance of the polyanion compound. An anion (AyOz) of the polyanion compound includes any one of PO₄³⁻, BO₃³⁻, and SiO₄⁴⁻ or combinations of a plurality of the anions. For a transition metal included in the metal part (M) of the polyanion compound, Fe, Mn, Co, Ni, and the like are typified. It is noted that a part of M may include a main group element such as Mg.

Moreover, when the particle diameter of the polyanion compound is too large, the diffusion length is increased to cause a decrease in output. On the other hand, when the particle diameter is excessively decreased, it is likely that it is difficult to increase the packing density when an electrode is formed and energy density is practically decreased. Furthermore, particles whose particle diameter is excessively decreased are likely to cause aggregations when the particles are formed into slurry in an electrode producing process, and it is likely to impair the smoothness and uniformity of the electrode. To impair the smoothness and uniformity of the electrode also leads to a degradation of the battery characteristics. Therefore, the particle diameter of a positive electrode active material particle is preferably in a predetermined range. In the case of the present invention, the average primary particle diameter was preferably in a range of 10 to 150 nm. In addition, it is preferable that prior to forming slurry, primary particles be formed into secondary particles in the state in which the primary particles are aggregated by sintering, for example, which also contributes to the improvement of packing density.

According to the present invention, it is possible to provide a positive electrode active material for lithium secondary batteries that a highly safe polyanion compound is used, a capacity, a rate characteristic, and energy density higher than a lithium secondary battery using a previously existing polyanion positive electrode active material are achieved, and the smoothness and uniformity of an electrode are excellent. As a result, the performances of a positive electrode for lithium secondary batteries and a lithium secondary battery produced using the positive electrode active material for lithium secondary batteries are improved.

The positive electrode active material for lithium secondary batteries can be used for a positive electrode as secondary particles as described above. A method for producing a positive electrode active material formed of secondary particles of a polyanion compound includes the steps of: mixing a lithium compound, a transition metal compound to be a metallic element source, and a phosphoric acid compound; pre-calcining the mixture; mixing a pre-calcined body with a carbon source; forming secondary particles; and main calcining.

Moreover, in the present invention, it is possible to provide the following improvement and modification in the positive electrode active material for lithium secondary batteries described above.

(1) The polyanion compound has an olivine structure expressed by chemical formula 2 below,

LiMPO₄ (chemical formula 2)

(where M is at least one kind of Fe, Mn, Co, and Ni).

(2) M in the polyanion compound having an olivine structure includes Mn and Fe and a ratio of F occupied in M is greater than 0 mol % and not greater than 50 mol % in a mol ratio.

(3) A content of the carbon ranges from 2 to 5 percent by mass.

In the following, an embodiment of the present invention will be described more in detail. However, the present invention is not limited to the embodiment taken here, and can be appropriately combined and modified within the scope not deviating from the teachings.

### [Positive Electrode Active Material for Lithium Secondary Batteries]

As discussed above, the positive electrode active material for lithium secondary batteries according to the present invention is a positive electrode active material for lithium secondary batteries including a polyanion compound particle coated with carbon, and the polyanion compound particle has a structure expressed by chemical formula 1.

For the nonaqueous electrolyte solution of a lithium secondary battery, such nonaqueous electrolyte solutions are widely known in which a supporting electrolyte (an electrolyte) such as lithium hexafluorophosphate is dissolved in a nonaqueous solvent such as ethylene carbonate (EC) and propylene carbonate (PC). However, since these nonaqueous solvents are inflammable (flash points of EC and PC are temperatures of 130 to 140° C., for example), the nonaqueous solvents are theoretically inflamed when there is a cause of flames. When the lithium secondary battery is turned into a high temperature state caused by overcharge, for example, it is likely that when constituent materials discharge oxygen, the oxygen reacts with a nonaqueous electrolyte solution to cause inflammation.

As discussed above, the polyanion compound expressed by chemical formula 1 described above has a strong polyanion bond (A-O bond in chemical formula 1), and oxygen is not desorbed even at high temperatures. On this account, even in the case where the lithium secondary battery is at high temperatures, the electrolyte solution is not flamed. Therefore, it is possible to provide a highly safe lithium secondary battery.

Preferably, the polyanion compound is a compound having an olivine structure expressed by chemical formula 2 described above.

Moreover, preferably, M in the polyanion compound having an olivine structure includes Mn and Fe, and a ratio of Fe occupied in M is greater than 0 mol % and not greater than 50 mol % in a mol ratio. In M in chemical formula 1, the resistance becomes lower as the ratio of Fe is higher, and the average voltage becomes higher as the ratio of Mn is higher. When the average voltage becomes high, energy density (capacity×voltage) becomes high. However, when Mn is 100%, the resistance is too high to obtain the capacity, and energy density is also decreased.

When Fe is added as M by about 20%, the resistance is decreased and the capacity is obtained as well, so that high energy density is obtained. However, although the resistance becomes low and a high capacity is obtained in a region where the amount of Fe is too large, the effect of a decrease in the average voltage is higher than the effect of an increase in the capacity, and energy density is decreased.

As described above, preferably, M in the polyanion compound includes Mn and Fe, and a ratio of Fe occupied in M is greater than 0 mol % and not greater than 50 mol % in a mol ratio.

The polyanion compound according to the present invention has a roughness factor expressed by equation 1 in a range of 1 to 2.

Here, the roughness factor will be described. As expressed by the equation above, the roughness factor means a ratio (a/b) between a specific surface area (a) measured using a BET method and a specific surface area (b) calculated from the average primary particle diameter calculated using a Scherrer equation from an X-ray diffraction measurement result supposing that the shape of the primary particle is a sphere in the positive electrode active material including the polyanion compound particle, and the roughness factor expresses the degree of the surface roughness of the particles. The value of the roughness factor is more increased as the particle has a larger surface roughness and many irregularities.

Moreover, the value of the roughness factor becomes smaller as the specific surface area is more decreased by an aggregation of particles by sintering, for example. In other words, since the specific surface area of the particle is greater as the value of the roughness factor is greater, the reactivity of the positive electrode active material with the electrolyte becomes high.

Although the description will be made in detail in examples described later, the roughness factor of the positive electrode active material according to the present invention ranges from 1 to 2, and this value is greater than the value of a polyanion positive electrode active material produced by a previously existing producing method (less than one). On this account, the lithium secondary battery produced using the positive electrode active material according to the present invention has a higher reactivity of the positive electrode active material with the electrolyte than in a lithium secondary battery using a previously existing polyanion positive electrode active material having the same particle diameter, and can achieve a high capacity, a high rate characteristic, and high energy density. When the roughness factor is smaller than one, it is not enabled to obtain the effect of improving the reactivity of the positive electrode active material with the electrolyte described above. Moreover, when the roughness factor is greater than two, the shape of the positive electrode active material is greatly out of a sphere, which is not preferable because it is not enabled to increase the packing density in producing the electrode. It is noted that in the present invention, a range of “1 to 2” means that the roughness factor is one or greater and two or less. A method for producing a positive electrode active material for lithium secondary batteries according to the present invention in which the roughness factor is in a range of 1 to 2 will be described later in detail.

The positive electrode active material according to the present invention is secondary particles that are aggregations of a large number of primary particles in the average particle size ranging from 10 to 150 nm. When the average primary particle diameter is less than 10 nm, aggregations are easily taken place, and particles in a diameter of about a few mm are sometimes produced in slurry. When the average primary particle diameter exceeds the thickness of the electrode, the smoothness and uniformity of the electrode are decreased. Moreover, when the average primary particle diameter is greater than 150 nm, the specific surface area becomes small, and it is difficult to sufficiently secure the reactivity of the positive electrode active material with the electrolyte.

Generally, in the lithium secondary battery, the specific surface area of the positive electrode active material becomes greater as the average primary particle diameter of the positive electrode active material is smaller, and the reactivity of the positive electrode active material with the electrolyte is increased to improve the characteristics. However, on the other hand, aggregations are more easily taken place as the particle diameter is smaller, and the smoothness and uniformity of the electrode are decreased. The positive electrode active material according to the present invention has the roughness factor greater than that of a positive electrode active material using a previously existing polyanion compound particle as described above, so that it is possible to achieve a capacity, a rate characteristic, and energy density higher than previously existing ones even the average primary particle diameter in in a range that can provide an excellent smoothness and uniformity of the electrode (10 to 150 nm).

It is noted that in the present invention, the average primary particle diameter is a value found from patterns obtained according to powder X-ray diffraction measurement. Methods for measuring and calculating the average primary particle diameter will be described in detail in the examples.

Preferably, a polyanion compound particle according to the present invention is covered with carbon, and the content of carbon ranges from 2 to 5 percent by mass in the positive electrode active material. It is noted that in the polyanion compound particle according to the present invention, it is considered that carbon exists in the particles and exists between the particle and the particle, other than the surfaces of the particles. “The content of carbon” described above also includes the amount of carbon that exists other than the surfaces of the polyanion compound particles. When the content of carbon is less than 2 percent by mass, electron conduction is decreased, and it is not enable to obtain sufficient battery performances. Moreover, when the content of carbon is greater than 5 percent by mass, energy density is decreased as well as the specific surface area is increased, and the smoothness and uniformity of the electrode are decreased. “To cover” in the present invention is used for the meaning that includes the forms described above.

### [Method for Producing the Positive Electrode Active Material for Lithium Secondary Batteries]

A method for producing the positive electrode active material for lithium secondary batteries according to the present invention will be described. The present invention is targeted for positive electrode active materials including compounds having an olivine structure that it is necessary to decrease the particle diameter to 200 nm or less to achieve a low resistance for use. Fine particles whose particle diameter is 200 nm or less easily cause aggregations, which easily lead to a decrease in the specific surface area and a decrease in the roughness factor. On this account, in order to increase the roughness factor, it is necessary to improve the surface roughness of active material particles and to perform a producing method that prevents aggregations and sintering.

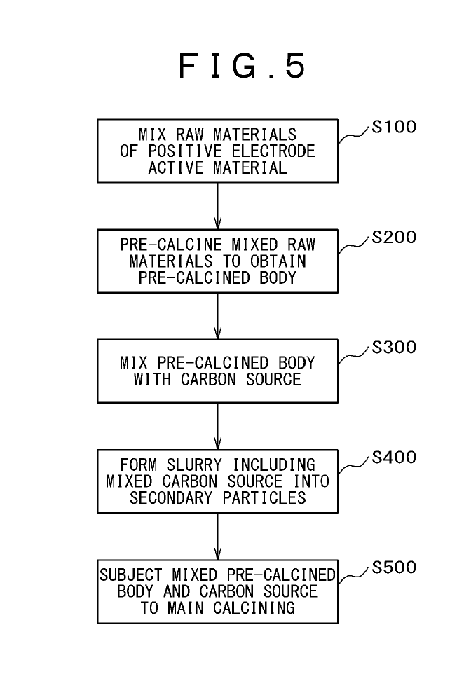

The method for producing the positive electrode active material for lithium secondary batteries according to the present invention includes (i) mixing raw materials, (ii) pre-calcining, (iii) mixing a carbon source, and (ix) main calcining, in which calcining is performed at twice or greater according to a solid phase method. The production of the positive electrode active material according to the solid phase method is a method in which raw materials are sufficiently mixed and then heated matching with a target composition to cause a solid phase reaction. FIG. 5 is a producing flow of the positive electrode active material according to the present invention.

The producing method according to the present invention includes a solid phase calcining step at twice or greater in the production of the positive electrode active material. In the calcining steps other than the final calcining step (in the following, referred to as main calcining), at least one calcining step (in the following, referred to as pre-calcining) is performed at a temperature that is a crystallization temperature or greater and a temperature not greatly exceeding the crystallization temperature in solid phase reactions. Preferably, in the final calcining step, calcining is performed at a temperature of 600° C. or greater at which a carbon source is carbonized. Preferably, pre-calcining is performed in an oxidizing atmosphere, air, for example, and main calcining is performed in a non-oxidizing atmosphere. Pre-calcining and main calcining can be performed at twice or greater.

Particles produced according to this method have a large roughness factor and a specific surface area larger than particles having a small roughness factor in the same diameter, and are excellent reactivity with the electrolyte. In the case where the particle diameter is increased in the particles having a large roughness factor, it is possible that a resistance to a reaction is decreased (the reactivity with the electrolyte is improved) while suppressing a harmful effect of decreasing the particle diameter (aggregations of the particles, for example). In the case where the particle diameter is decreased, it is possible to obtain particles of a lower resistance. In the following, the steps mentioned above will be described in order.

(i) Mixing Raw Materials

The positive electrode active material for lithium secondary batteries according to the present invention can provide microcrystals by pre-calcining at a temperature that is a crystallization temperature or greater and a temperature not greatly exceeding the crystallization temperature. In main calcining described later, it is possible to obtain primary particles including a large number of the microcrystals. The primary particles in this form have large irregularities on the surface and a large roughness factor. At this time, the size of microcrystals forming the primary particles depends on the particle diameter of raw materials, for example. Since the surface roughness becomes larger as the microcrystals are made smaller, it is desirable that the raw materials of the positive electrode active material have a particle diameter as small as possible (1 μm or less, for example). Moreover, in the case where raw materials are not uniformly mixed, crystals to be generated are oversized in pre-calcining, or heterogeneous components (compounds other than the polyanion compound including Mn oxides or Fe oxides and MnP₂O₇, for example) are generated. It is desirable to further uniformly mix the raw materials.

Methods for uniformly mixing raw materials preferably include a method for mechanically crushing and mixing raw materials using a bead mill or the like, and a method for mixing raw materials in which raw materials are formed into a liquid solution state using an acid, alkaline, chelating agent, or the like and then dried. More specifically, the method in which raw materials are mixed after the raw materials are formed into a liquid solution state is advantageous to the precipitation of finer microcrystals because the raw materials are mixed at molecule level.

For the raw materials of the positive electrode active material, it is desirable to use salts, described later, which do not remain after pre-calcining. For a raw material for Li in chemical formula 1, lithium acetate, lithium carbonate, lithium hydroxide, or the like can be used. For the raw material of M, at least one of acetate, oxalate, citrate, carbonate, and tartrate, for example, can be used. For the raw material of AyOz, acidic polyanion compounds or salts that an acid is neutralized (ammonium salts and lithium salts, for example) can be used. For example, in the case of PO₄, lithium dihydrogen phosphate, ammonium dihydrogen phosphate, diammonium hydrogen phosphate, or the like can be used.

(ii) Pre-Calcining

It is necessary that the pre-calcining temperature be the crystallization temperature of the polyanion compound or greater and a temperature not greatly exceeding the crystallization temperature. When the pre-calcining temperature is lower than the crystallization temperature, a large amount of unreacted substances is produced in pre-calcining. The unreacted substances are transitioned to an active material phase in main calcining described later. However, in the transition, a plurality of the particles is bonded to one another to cause the aggregation and sintering of the particles. When the aggregation and sintering of the particles occur, the specific surface area is decreased, and the reactivity is dropped. Moreover, it is possible to increase the diameter of the particles after produced by increasing the pre-calcining temperature. However, when the pre-calcining temperature is too high, the particles are oversized to decrease the specific surface area of the positive electrode active material, and the reaction area between the positive electrode active material and the electrolyte is decreased.

Since the crystallization temperature and the speed of growth are varied depending on polyanion compounds, a preferred range of the pre-calcining temperature is also varied. In the compound having an olivine structure expressed by chemical formula 2, since the crystallization temperature is about 420° C. (source: Robert Dominko, Marjan Bele, Jean-Michel Goupil, Miran Gaberscek, Darko Hanzel, Iztok Arcon, and Janez Jamnik, “Wired Porous Cathode Materials: A Novel Concept for Synthesis of LiFePO4” Chemistry of Materials 19 (2007), pp. 2960-2969), it is necessary to perform calcining at a temperature of 420° C. or greater. Moreover, oversized particles can be suppressed as long as the temperature is 600° C. or less.

When the temperature is higher than a temperature of 600° C., it is not preferable because crystal growth is greatly promoted, the particles are oversized, and the reaction area between the positive electrode active material and the electrolyte is decreased. More specifically, it is more preferable that the temperature be in a range of temperatures of 440 to 500° C. When the temperature is 440° C. or greater, the temperature in the overall sample is at a crystallization temperature or greater even in the case where the temperature is varied more or less in the sample. Moreover, when the temperature is 500° C. or less, the average primary particle diameter is 100 nm or less after pre-calcining, and particles in a diameter of 100 nm or less can be obtained after main calcining, described later.

Preferably, the pre-calcining atmosphere is an oxidizing atmosphere. When pre-calcining is performed in an oxidizing atmosphere in a temperature range described above, organic substances (including a part of organic substances such as carbon) derived from the raw materials are eliminated, so that it possible to prevent these organic substances from being mixed into crystals. Therefore, in the oxidizing atmosphere, it is possible to enhance crystallizability more than in the case where calcining is performed in an inert atmosphere or in a reducing atmosphere. More specifically, in the case where raw materials are uniformly mixed after a liquid solution state, since organic substances are uniformly mixed in the raw materials, organic substances are easily taken into crystals in the inert atmosphere or the reducing atmosphere.

In order to remove organic substances, since the pre-calcining temperature is preferably 400° C. or greater regardless of the crystallization temperature described above, pre-calcining is preferably performed at temperatures of 420 to 600° C.

A method for obtaining an oxidizing atmosphere, it is easy to use a gas including oxygen. Moreover, it is preferable to use air as a method for obtaining an oxidizing atmosphere because of costs.

(iii) Mixing and Covering a Carbon Source

Since the pre-calcined body obtained in the description above has a low crystallizability, it is necessary to perform calcining at higher temperatures in order to improve crystallizability. However, in the case where main calcining is simply performed at high temperatures, microcrystals obtained by pre-calcining are easily bonded to one another and grown, and the particles are oversized. Therefore, prior to main calcining, the pre-calcined body is mixed with organic substances or carbon to be a carbon source, and is covered with carbon. The organic substances or carbon is brought into intimate contact with the surfaces of the microcrystals obtained by pre-calcining to cover the microcrystals, so that it is possible to suppress such an event that the crystals are bonded to one another to grow the crystals in main calcining. For the carbon source, acetylene black, graphite, sugar, organic acids, and pitch, for example, are preferable. Among others, in consideration of adhesion to the pre-calcined body surface, sugar, organic acids, and pitch are more preferable.

For a method in which the microcrystals obtained by pre-calcining is mixed and covered with a carbon source and the microcrystals can be downscaled as well, such a method is desirable in which a mechanical pressure is applied using a ball mill or a bead mill. Moreover, it is also preferable to form secondary particles in a form in which a plurality of the particles (the primary particles) as described above is aggregated and integrated with one another. The secondary particles are formed, so that the particle diameter is increased to some extent, which contributes to the improvement of the volume and density of the electrode, for example. In the case where secondary particles are formed, it is preferable to form secondary particles prior to main calcining.

(iv) Main Calcining

In main calcining, the carbon source covered on the pre-calcined body in the description above is carbonized to improve the electrical conductivity of the positive electrode active material, and the crystallizability of the active material particles is improved, or the active material particles are crystallized. In main calcining, since it is necessary to carbonize the organic substances (the carbon source) for preventing a metallic element from being oxidized, main calcining is performed in an inert atmosphere or a reducing atmosphere. The main calcining temperature is desirably 600° C. or greater in order to carbonize the organic substances. Moreover, main calcining is desirably performed at a temperature, at which the thermal decomposition of the positive electrode active material occurs, or less. In the compound having an olivine structure, the range of a main calcining temperature desirably ranges at temperatures of 600 to 850° C. When the temperature is 600° C. or greater, it is possible that the carbon source is carbonized and the electrical conductivity is provided. When the temperature is 850° C. or less, the compound having an olivine structure is not decomposed. Moreover, the temperature desirably ranges at temperatures of 700 to 750° C. In this temperature range, the electrical conductivity of carbon can be sufficiently improved, and the production of impurities caused by a reaction of carbon with the compound having an olivine structure can be suppressed.

Generally, methods other than the solid phase method for the compound having an olivine structure include a hydrothermal synthesis method. According to a hydrothermal synthesis method, dispersed primary particles with no impurities can be obtained. However, particles produced according to a hydrothermal synthesis method have a smooth surface. This is because the nucleus is grown according to the speed of growth of the crystal plane. As compared with these smooth particles, the particles according to the producing method have a large specific surface area in the same particle diameter and a high reactivity with the electrolyte.

It is noted that in the description above, the producing method is described in which calcining is performed by pre-calcining and main calcining at one time each in the solid phase method. Pre-calcining may be performed at twice or greater as long as the conditions according to the present invention are satisfied.

In the method for producing the positive electrode active material for lithium secondary batteries according to the present invention described above, the primary particles including a large number of microcrystals can be obtained, and the positive electrode active material having a large roughness factor can be obtained as compared with a positive electrode active material using a previously existing polyanion compound.

### [Positive Electrode for Lithium Secondary Batteries]

A positive electrode for lithium secondary batteries according to the present invention has a configuration in which a positive electrode mixture including the positive electrode active material according to the present invention described above and a binder is formed on a current collector. The positive electrode mixture may be added with an auxiliary conductive agent for complementing electron conduction as necessary. Materials for the binder, the auxiliary conductive agent, and the current collector are not limited particularly, and previously existing materials can be used.

For the binder, PVDF (polyvinylidene fluoride) or polyacrylonitrile is preferable. The types of the binders are not limited more specifically as long as binders have sufficient binding properties.

For the auxiliary conductive agent, carbon auxiliary conductive agents such as acetylene black and graphite powder are preferable. Since the positive electrode active material according to the present invention has a high specific surface area, the auxiliary conductive agent desirably has a large specific surface area in order to form a conducting network. More specifically, acetylene black and the like are more preferable. When the binder having excellent adhesion as described above is used as well as the auxiliary conductive agent is mixed in order to provide electrical conductivity, a strong conducting network is formed. Therefore, it is possible that the electrical conductivity of the positive electrode is improved and the capacity and the rate characteristic are improved.

For the current collector, a support having electrical conductivity such as aluminum foil is preferable.

### [Lithium Secondary Battery]

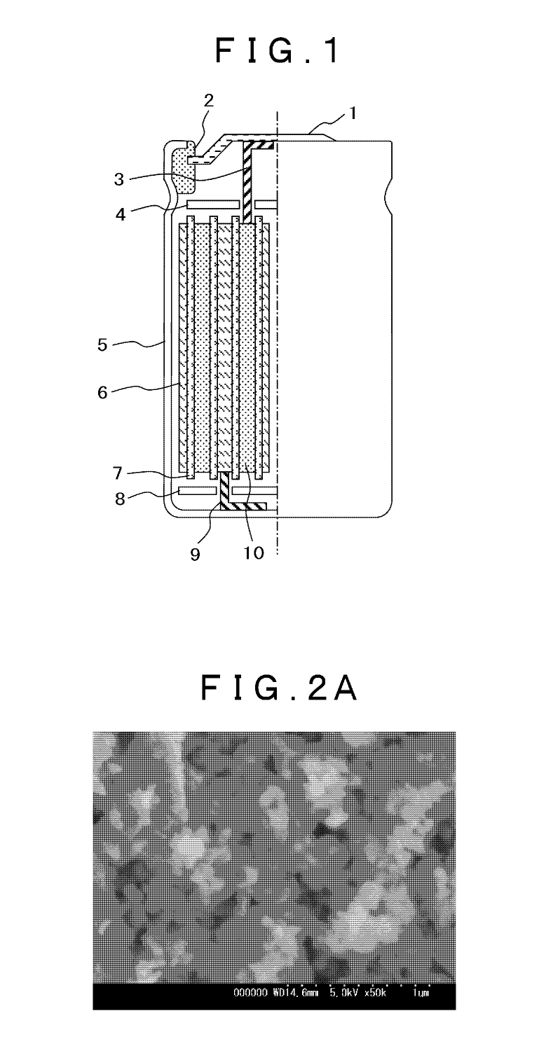

The configuration of a lithium secondary battery will be described. FIG. 1 is a schematic diagram of a half cross section of an exemplary lithium secondary battery to which the present invention is applied. As illustrated in FIG. 1, a positive electrode 10 and a negative electrode 6 are carefully wound as a separator 7 is sandwiched between the electrodes so as not to directly contact the electrodes with each other, and an electrode group is formed. It is noted that the structure of the electrode group is not limited to a winding in a shape such as a cylindrical shape and a flat shape. The structure may be in a shape in which rectangular electrodes are stacked.

A positive electrode lead 3 is attached to the positive electrode 10, and a negative electrode lead 9 is attached to the negative electrode 6. The leads 3 and 9 can adopt a given shape such as a wire shape, foil shape, and plate shape. Such a structure and a material are selected that an electrical loss can be decreased and chemical stability can be secured.

The electrode group is housed in a battery container 5, and the inserted electrode group is not directly contacted with the battery container 5 by an insulating plate 4 disposed on the upper part of the battery container 5 and an insulating plate 8 disposed on the bottom part. Moreover, a nonaqueous electrolyte solution (not shown) is filled in the battery container 5. For the shape of the battery container 5, generally, a shape matched with the shape of the electrode group is selected (a cylindrical shape, flat elliptic cylindrical shape, and prism, for example). For the insulating plates 4 and 8, given materials that do not react with the nonaqueous electrolyte solution and have excellent airtightness are preferable (a thermosetting resin and a glass hermetic seal, for example)

The material of the battery container 5 is selected from materials corrosion resistant to nonaqueous electrolyte solutions such as aluminum, stainless steel, and nickel plated steel. A method for mounting a battery cover 1 on the battery container 5 can also include methods such as caulking and bonding in addition to welding.

The positive electrode 10 configuring the lithium secondary battery is prepared in which positive electrode mixture slurry including the positive electrode active material is coated and dried on one side or both sides of a positive electrode current collector, and they are compression molded using a roll pressing machine, for example, and cut into a predetermined size. For the positive electrode current collector, aluminum foil having thicknesses of 10 to 100 μm, aluminum perforated foil having thicknesses of 10 to 100 μm and hole diameters of 0.1 to 10 mm, expanded metal, a foamed aluminum plate, and the like are used. For the material, stainless steel, titanium, and the like are also applicable in addition to aluminum.

Similarly, the negative electrode 6 configuring the lithium secondary battery is prepared in which negative electrode mixture slurry including a negative active material is coated and dried on one side or both sides of a negative electrode current collector, and they are compression molded using a roll pressing machine, for example, and are cut into a predetermined size. For the negative electrode current collector, copper foil having thicknesses of 10 to 100 μm, copper perforated foil having thicknesses of 10 to 100 μm and hole diameters of 0.1 to 10 mm, expanded metal, a foamed copper plate, and the like are used. For the material, stainless steel, titanium, nickel, and the like are also applicable in addition to copper.

The method for coating the positive electrode mixture slurry and the negative electrode mixture slurry is not limited specifically. Previously existing methods can be used (for example, a doctor blade method, dipping, and spraying).

The positive electrode active material used for the positive electrode 10, the positive electrode active material according to the present invention described above is used. The positive electrode active material is mixed with a binder, a thickener, a conductive agent, a solvent, and the like as necessary, and the positive electrode mixture slurry is prepared.

The negative active material used for the negative electrode 6 is not limited more specifically as long as the negative active material is a material that can occlude and emit lithium ions. For example, artificial graphite, natural graphite, amorphous carbons, hardly graphitizable carbons, activated carbons, coke, pyrocarbons, metal oxides, metal nitrides, lithium metals or lithium metal alloys, and the like are named. Any one of them or a mixture of two kinds or more of them can be used. Among others, it is preferable to include amorphous carbon as a negative active material because amorphous carbon is a material having a small volume change in the occlusion and emission of lithium ions and the cycle characteristics in charging and discharging are improved. The negative active material is mixed with a binder, a thickener, a conductive agent, a solvent, and the like as necessary, and the negative electrode mixture slurry is prepared.

For the negative electrode auxiliary conductive agent, electrical conductive polymeric materials (polyacene, polyparaphenylene, polyanion, and polyacetylene, for example) can be used in addition to the auxiliary conductive agent of the positive electrode active material described above.

The binder, the thickener, and the solvent used for mixture slurry are not limited specifically, and ones similar to previously existing ones can be used.

Since the separator 7 is necessary to transmit lithium ions in charging and discharging the secondary battery, a porous body is preferable (the pore diameter ranges from 0.01 to 10 μm, and the porosity ranges from 20 to 90%, for example). For the material of the separator 7, a polyolefin high molecular sheet (polyethylene and polypropylene, for example), a multi-layer structure sheet that a polyolefin high molecular sheet is welded to a fluorine high molecular sheet (polyethylene tetrafluoride, for example), or a glass fiber sheet can be preferably used. Moreover, it may be fine that a mixture of ceramics and a binder is formed in a thin layer on the surface of the separator 7.

For the electrolyte, lithium salts such as LiPF₆, LiBF₄, LiCF₃SO₃, LiN(SO₂CF₃)₂, LiN(SO₂F)₂, and the like can be used alone or in a mixture. For a solvent that dissolves lithium salts, linear carbonates, cyclic carbonates, cyclic esters, nitrile compounds, and the like can be used. More specifically, ethylene carbonate, propylene carbonate, diethyl carbonate, dimethoxyethane, γ-butyrolactone, n-methylpyrrolidinone, acetonitrile, and the like can be used.

In addition to this, a polymer gel electrolyte and a solid electrolyte can also be used as an electrolyte. In the case where a solid high molecular electrolyte (a polymer electrolyte) is used, an ionic conductive polymer such as ethylene oxide, acrylonitrile, polyvinylidene fluoride, methyl methacrylate, and a polyethylene oxide of hexafluoropropylene can be preferably used. In the case where these solid high molecular electrolytes are used, the separator 7 can be omitted.

The positive electrode, the negative electrode, the separator, and the electrolyte described above are used to configure lithium secondary batteries in various forms such as a cylindrical battery, a rectangular battery, and a laminate battery.

In the following, the present invention will be described more in detail according to examples and comparative examples. It is noted that the present invention is not limited to these examples.

### Example 1

Example 1 describes results that a positive electrode active material made of primary particles of a polyanion compound is produced and electrode characteristics are evaluated using a model cell including the positive electrode active material.

### Example 1-1

### (i) Mixing Raw Materials

For a metal source, citric acid iron (FeC₆H₅O₇.nH₂O) and acetic acid manganese tetrahydrate (Mn(CH₃COO)₂.4H₂O) were used and measured as the ratio between Fe and Mn was 2:8, and dissolved in pure water. In the solution, citric acid monohydrate (C₆H₈O7.H₂O) was added as a chelating agent. The amount of the chelating agent was adjusted according to the loadings of other citrates in such a manner that citric acid ions were added in an amount of 80 mol % to the total amount of metal ions. When a chelating agent is added, citric acid ions are coordinated around metal ions, so that a raw material solution uniformly dissolved can be obtained in which the generation of precipitation is suppressed.

Subsequently, lithium dihydrogen phosphate (H₂LiO₄P) and lithium acetate aqueous solution (CH₃CO₂Li) were added, and a solution was obtained in which all the raw materials were dissolved. The concentration of the solution was 0.2 mol/l based on the metal ions.

The preparation composition was Li:M (metal ions):PO₄=1.05:1:1, and Li was rich. The reason why this preparation composition was provided is that cations are prevented from being mixed and the volatilization of Li is complemented in calcining. Moreover, this is also one of reasons that even though lithium phosphate (Li₃PO₄) is produced because of rich Li, the substance is highly Li ionic conductive and has a small adverse effect.

The solution obtained in the description above was dried using a spray dryer under the conditions that the inlet temperature was 195° C. and the outlet temperature was 80° C., and raw material powder was obtained. The raw material powder is in the state in which elements are uniformly dispersed in the citric acid matrix.

### (ii) Pre-Calcining

The raw material powder obtained in the description above was pre-calcined using a box electric furnace. The calcining atmosphere was air, the calcining temperature was 440° C., and calcining hours were ten hours.

### (iii) Mixing and Covering a Carbon Source

Sucrose in an amount of a mass ratio of 7 percent by mass was added as a carbon source and a particle diameter control agent to the pre-calcined body obtained in the description above, and they were crushed and mixed for two hours using a ball mill.

### (iv) Main Calcining

Subsequently, main calcining was performed using a tubular furnace that was enabled to control atmospheres. The calcining atmosphere was an argon (Ar) atmosphere, the calcining temperature was 700° C., and calcining hours were ten hours.

In the steps described above, a positive electrode active material was obtained.

Subsequently, the positive electrode active material obtained in the description above was used to prepare a positive electrode. In the following, a method for preparing an electrode will be described.

The positive electrode active material, a conductive agent, a binder, and a solvent were kneaded on a mortar, and positive electrode mixture slurry was prepared. For the conductive agent, acetylene black (DENKA BLACK (registered trademark) made by Denki Kagaku Kogyo Kabusikikaisya) was used, for the binder, denatured polyacrylonitrile was used, and for the solvent, N-methyl-2-pyrrolidone (NMP) was used. It is noted that for the binder, a solution dissolved in NMP was used. For the composition of the electrode, the mass ratio among the positive electrode active material, the conductive agent, and the binder was 82.5:10:7.5.

Subsequently, slurry of these positive electrode mixture was coated on one side of a positive electrode current collector (aluminum foil) having a thickness of 20 μm using a doctor blade method in coating amounts of 5 to 6 mg/cm², this was dried at a temperature of 80° C. for one hour, and a positive electrode mixture layer (thicknesses of 38 to 42 μm) was formed. Subsequently, the positive electrode mixture layer was punched in a disk shape in a diameter of 15 mm using a punning tool. The punched positive electrode mixture layer was compression molded, and a positive electrode for lithium secondary batteries was obtained.

All the electrodes were prepared fitting in a range of the coating amounts and the thicknesses described above, and the electrode structure was kept constant. The prepared electrodes were dried at a temperature of 120° C. It is noted that in order to remove the influence of moisture, all manipulations were operated in a dry room.

In order to evaluate the capacity and the rate characteristic, a three-pole model cell, which a battery was simply reproduced, was prepared by procedures below. A test electrode punched in a diameter of 15 mm, an aluminum current collector, metal lithium for a counter electrode, and metal lithium for a reference electrode were stacked through a separator immersed in an electrolyte solution. For the electrolyte solution, such an electrolyte solution was used in which LiPF₆ was dissolved in a solvent that ethylene carbonate (EC) and ethyl methylcarbonate (EMC) were mixed at a ratio of 1:2 (a capacity ratio) in a ratio of 1 mol/1 and vinylene carbonate (VC) in an amount of 0.8 percent by mass was added to this solution. This stacked body was clamped using two SUS end plates and tightened with bolts. This was put into a glass cell to form a three-pole model cell.

The composition and producing conditions of the positive electrode active material according to example 1-1 is shown in Table 1, described later.

(Test Evaluation)
(a) XRD Measurement (Crystalline Phase Identification and Average Primary Particle Diameter Evaluation)

Powder X-ray diffraction measurement (XRD measurement) was performed according to procedures below, and the crystalline phase of the carbon coated positive electrode active material obtained in the description above was identified, and the average primary particle diameter was calculated. For a measurement device, a powder X-ray diffraction measurement device (a model of RINT-2000 made by Rigaku Corporation) was used. The measurement conditions were a focusing method, in which CuKα rays was used for X-rays, the X-ray output was 40 kV×40 mA, the scan range was 2θ=15 to 120 degrees, a divergence slit was DS=0.5 degrees, a solar slit was SS=0.5 degrees, a light receiving slit was RS=0.3 mm, the step width was 0.03°, and measuring time per step was 15 seconds. For diffraction patterns obtained by measurement, crystalline phases were identified using an ICSD (Inorganic Crystal Structure Database).

Measurement data was smoothed by a Savitzky-Golay method, the background and CuKα₂ rays were removed, an integral width βexp of the peak of crystal plane (101) at this time (the space group was Pmna) was determined. Moreover, an integral width βi was determined when a standard Si sample (product name: 640d made by NIST) was measured using the same device under the same conditions, and an integral width β was defined by Equation 2 below. This integral width was used, a crystallite diameter D was determined using a Scherrer equation expressed by Equation 3 below, and this was defined as the average primary particle diameter. Where λ was defined as the wavelength of an X-ray source, θ was defined as an angle of reflection, K was defined as Scherrer the constant, and K=4/3.

$$\begin{matrix}[ Equation 2 ] & \\ β = \sqrt{{β}_{ex p}^{2} - {β}_{i}^{2}} & ( Equation 2 ) \\ [ Equation 3 ] & \\ D = \frac{K λ}{β cos θ} & ( Equation 3 )\end{matrix}$$

The identification result of the crystalline phase and the measured value of the average primary particle diameter are shown in Table 3, described later.

(b) Specific Surface Area Measurement (Roughness Factor Evaluation)

When substances having a large specific surface area such as carbon are attached, values higher than the value of the specific surface area of the positive electrode active material itself are sometimes measured. Moreover, the specific surface area is greatly changed according to the amount of a carbon coating, and the specific surface area does not reflect the characteristics of the active material particles themselves. On this account, in the present invention, when an actually measured value (a) of the specific surface area of the positive electrode active material particles was measured, particles that the coating on the surface of carbon was removed were used. Although a removal method is not limited, the shape of the particle surface does not have to be changed. For example, in the case of a carbon coating, the particles are heated at a temperature of 450° C. for one hour in air, so that the carbon coating can be removed with no influence on the shape of the particle surface.

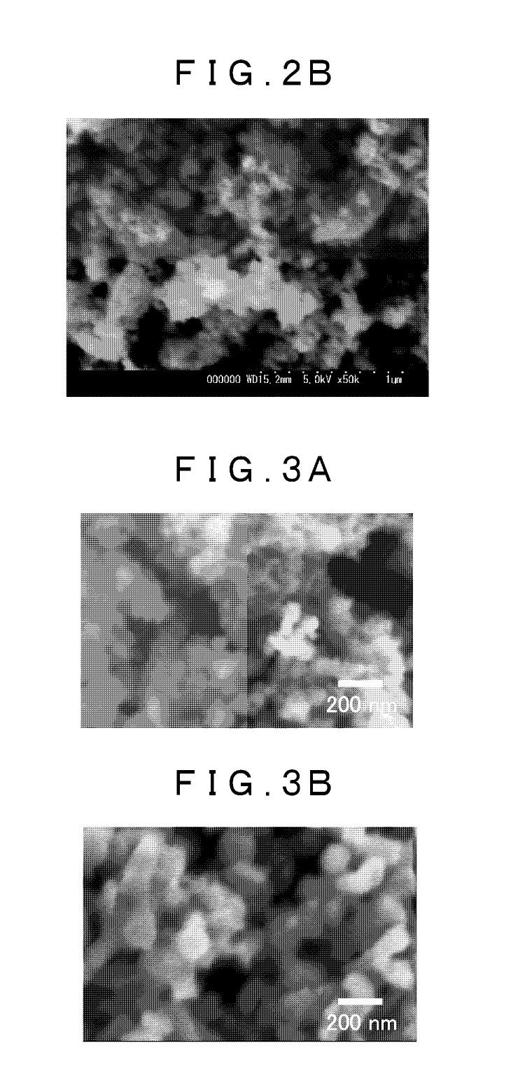

FIG. 2A is an appearance photograph (an SEM observation image) prior to a carbon coating removal process of the positive electrode active material for lithium secondary batteries according to the present invention. Moreover, FIG. 2B is an appearance photograph (an SEM observation image) after the positive electrode active material for lithium secondary batteries in FIG. 2A is heated at a temperature of 450° C. for one hour in air. As illustrated in FIGS. 2A and 2B, it is revealed that the appearance of particles is not changed before and after the carbon coating removal process.

The actually measured value (a) of the specific surface area was measured using an automatic specific surface area measurement device (a model of BELSORP-mini made by BEL Japan, Inc.). Furthermore, a calculated value (b) of the specific surface area was calculated using the value of the average primary particle diameter described above. The obtained values (a) and (b) were substituted into Equation 1, and a roughness factor was determined.

The actually measured value (a) of the specific surface area and the value of the roughness factor are shown together in Table 3.

It is noted that as described above, since the primary particle diameter calculated by the definitions above is a primary particle diameter measured by X-rays diffraction and evaluated by the crystallite diameter averaged from all the particles, in the primary particles configured of an aggregation including a large number of fine crystallites, the primary particle diameter is calculated in a diameter smaller than a general diameter, and is not matched with the case where individual particles are observed and actually measured using an electron microscope, for example. However, as a result that the particle diameter is calculated in a small diameter, the effect that a numerator (a) is increased is greater than the effect that a denominator (b) of the equation expressed by equation 1 is increased because the actually measured value of the specific surface area of the positive electrode active material is increased in the case where the crystallite becomes small, and the roughness factor is increased.

(c) Measurement of the Content of Carbon

The content of carbon of the positive electrode active material was measured using an infrared absorbing method after high frequency firing. The content of carbon is also shown in Table 3.

(d) Charging and Discharging Test (Capacity Evaluation)

The three-pole model cell prepared in the description above was subjected to a charging and discharging test below, and the initial capacity was evaluated. It is noted that the tests were performed in a glove box in an Ar atmosphere at an ambient temperature (25° C.). The current value was 0.1 mA, and constant current charge was performed up to a voltage of 4.5 V. After reaching a voltage of 4.5 V, constant voltage charge was performed until the current value is attenuated to 0.03 mA. After that, the model cell was discharged at a constant current of 0.1 mA up to a voltage of 2 V, and a discharge capacity at this time was defined as a capacity. The results are shown together in Table 3.

(e) Rate Characteristic Evaluation

After the charging and discharging tests were repeated for three cycles, and the rate characteristic was evaluated under the conditions below. Similarly to capacity measurement, a capacity when the model cell subjected to constant current charge and constant voltage charge was subjected to constant current discharge at a current value of 5 mA was defined as a rate characteristic. The results are shown together in Table 3.

(f) Energy Density Measurement

In the three-pole model cell prepared in the description above, a discharge curve (the capacity dependence of a battery voltage) was measured, the curve was subjected to numerical integration, and the energy density was calculated. The results are shown together in Table 3.

(g) SEM Observation

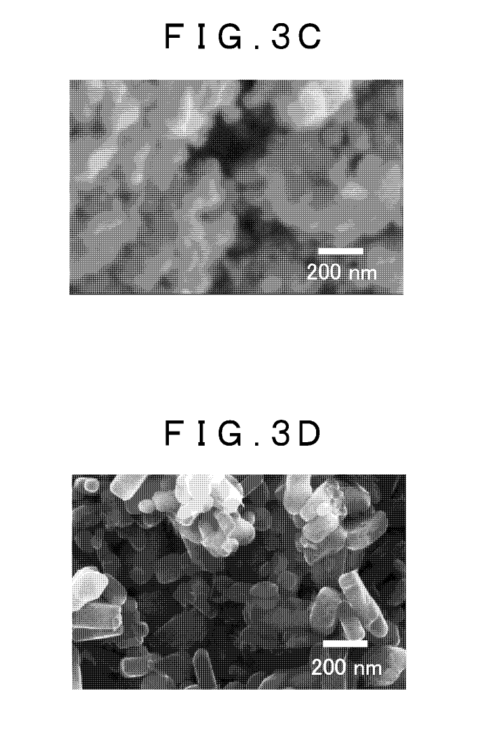

The sample surface of the positive electrode active material was observed by SEM measurement. For observation, a scanning electron microscope (a model of S-4300 made by Hitachi High-Technologies Corporation) was used. An appearance photograph of positive electrode active material powder according to example 1-1 is shown in FIG. 3A.

### Preparation of a Lithium Secondary Battery According to Example 1-2

LiFe_{0.2}Mn_{0.8}PO₄ was obtained by a method similar to example 1-1 except that the pre-calcining temperature was 600° C. XRD measurement, specific surface area measurement, charging and discharging tests, rate characteristic evaluation, energy density measurement, and SEM observation were also similarly performed. The composition and producing conditions of the positive electrode active material are shown in Table 1, and the measurement results are shown together in Table 3. Moreover, an appearance photograph of positive electrode active material powder according to example 1-2 is shown in FIG. 3B.

### Preparation of a Lithium Secondary Battery According to Example 1-3

LiMnPO₄ was obtained by a method similar to example 1-1 except that for a metal source, acetic acid manganese tetrahydrate (Mn(CH₃COO)₂.4H₂O) was used and Mn was occupied in the total amount of the transition metal. XRD measurement, specific surface area measurement, charging and discharging tests, rate characteristic evaluation, and energy density measurement were also similarly performed. The composition and producing conditions of the positive electrode active material are shown in Table 1, and the measurement results are shown together in Table 3.

### Preparation of a Lithium Secondary Battery According to Example 1-4

LiMnPO₄ was obtained by a method similar to example 1-3 except that the pre-calcining temperature was 600° C. XRD measurement, specific surface area measurement, charging and discharging tests, rate characteristic evaluation, and energy density measurement were also similarly performed. The composition and producing conditions of the positive electrode active material are shown in Table 1, and the measurement results are shown together in Table 3.

### Preparation of a Lithium Secondary Battery According to Example 1-5

LiFePO₄ was obtained by a method similar to example 1-1 except that for a metal source, only citric acid iron (FeC₆H₅O₇.nH₂O) was used and Fe was occupied in the total amount of the transition metal. XRD measurement, specific surface area measurement, charging and discharging tests, rate characteristic evaluation, and energy density measurement were also similarly performed. The composition and producing conditions of the positive electrode active material are shown in Table 1, and the measurement results are shown together in Table 3.

### Preparation of a Lithium Secondary Battery According to Example 1-6

LiFePO₄ was obtained by a method similar to example 1-5 except that the pre-calcining temperature was 600° C. XRD measurement, specific surface area measurement, charging and discharging tests, rate characteristic evaluation, and energy density measurement were also similarly performed. The composition and producing conditions of the positive electrode active material are shown in Table 1, and the measurement results are shown together in Table 3.

### Preparation of a Lithium Secondary Battery According to Example 1-7

LiMn_{0.77}Fe_{0.2}Mg_{0.03}PO₄ was obtained by a method similar to example 1-1 except that for a metal source, acetic acid manganese tetrahydrate (Mn(CH₃COO)₂.4H₂O) and citric acid iron (FeC₆H₅O₇.nH₂O) AND magnesium hydroxide (Mg(OH)₂) were used. XRD measurement, specific surface area measurement, charging and discharging tests, rate characteristic evaluation, and energy density measurement were also similarly performed. The composition and producing conditions of the positive electrode active material are shown in Table 1, and the measurement results are shown together in Table 3.

### Preparation of a Lithium Secondary Battery According to Reference Example 1-1

LiFe_{0.2}Mn_{0.8}PO₄ was obtained by a method similar to example 1-1 except that the pre-calcining temperature was 380° C. XRD measurement, specific surface area measurement, charging and discharging tests, rate characteristic evaluation, energy density measurement, and SEM observation were also similarly performed. The composition and producing conditions of the positive electrode active material are shown in Table 2, and the measurement result is shown in Table 4. Moreover, an appearance photograph of positive electrode active material powder according to reference example 1-1 is shown in FIG. 3C. It is noted that in the present specification, the reference example means that similarly to the present invention, pre-calcining was performed in an oxidizing atmosphere and main calcining in a non-oxidizing atmosphere, and a positive electrode active material was produced by a solid phase method. However, the pre-calcining temperature is lower than the olivine crystallization temperature. Therefore, the reference example is not publicly known in themselves, and described in order to show the importance of the roughness factor and the pre-calcining temperature according to the present invention.

### Preparation of a Lithium Secondary Battery According to Comparative Example 1

A hydrothermal synthesis method was performed. Lithium hydroxide (LiOH), phosphoric acid (H₃PO₄), sulfuric acid manganese (MnSO₄), and sulfuric acid iron (FeSO₄) were used for raw materials. The raw materials were measured so as to have a mol ratio of Li:PO₄:Mn:Fe=3:1:0.8:0.2. A lithium hydroxide aqueous solution was dropped in a solution that sulfuric acid manganese, sulfuric acid iron, and phosphoric acid were dissolved in pure water while stirring the solution, and a suspension including precipitation was obtained.

The obtained suspension was subjected to nitrogen bubbling, and sealed in a pressure container while purging nitrogen. The pressure container was heated at a temperature of 170° C. for five hours while rotated and stirred, and the obtained precipitation was filtered and cleaned, and then LiMn_{0.8}Fe_{0.2}PO₄ was obtained. Sucrose in an amount of a mass ratio of 7 percent by mass was added to LiMn_{0.8}Fe_{0.2}PO₄ obtained. The mixture was mixed for two hours using a wet ball mill. Subsequently, the mixture was baked using a tubular furnace that was enabled to control atmospheres, and carbon was coated. The calcining atmosphere was an Ar atmosphere, the calcining temperature was 700° C., and calcining time was three hours. In the steps described above, carbon coated LiFe_{0.2}Mn_{0.8}PO₄ was obtained. XRD measurement, specific surface area measurement, charging and discharging tests, rate characteristic evaluation, energy density measurement, and SEM observation were also similarly performed. The composition and producing conditions of the positive electrode active material are shown in Table 2, and the measurement result is shown in Table 4. Moreover, an appearance photograph of positive electrode active material powder according to comparative example 1-1 is shown in FIG. 3D.

### Preparation of a Lithium Secondary Battery According to Reference Example 1-2

LiMnPO₄ was obtained by being produced as similar to example 1-3 except that the pre-calcining temperature was 380° C. XRD measurement, specific surface area measurement, charging and discharging tests, rate characteristic evaluation, and energy density measurement were also similarly performed. The composition and producing conditions of the positive electrode active material are shown in Table 2, and the measurement result is shown in Table 4.

### Preparation of a Lithium Secondary Battery According to Comparative Example 1-2

LiMnPO₄ was obtained by a producing method similar to comparative example 1-1 except that lithium hydroxide, phosphoric acid, and sulfuric acid manganese were used for raw materials and the raw materials were measured and used in a mol ratio of Li:PO₄:Mn=3:1:1. XRD measurement, specific surface area measurement, charging and discharging tests, rate characteristic evaluation, and energy density measurement were also similarly performed. The composition and producing conditions of the positive electrode active material are shown in Table 2, and the measurement result is shown in Table 4.

### Preparation of a Lithium Secondary Battery According to Reference Example 1-3

LiFePO₄ was obtained by being produced as similar to example 1-5 except that the pre-calcining temperature was 380° C. XRD measurement, specific surface area measurement, charging and discharging tests, rate characteristic evaluation, and energy density measurement were also similarly performed. The composition and producing conditions of the positive electrode active material are shown in Table 2, and the measurement result is shown in Table 4.

### Preparation of a Lithium Secondary Battery According to Comparative Example 1-3

LiFePO₄ was obtained by a producing method similar to comparative example 1-1 except that lithium hydroxide, phosphoric acid, and sulfuric acid iron was used and the raw materials were measured and used in a mol ratio of Li:PO₄:Fe=3:1:1. XRD measurement, specific surface area measurement, charging and discharging tests, rate characteristic evaluation, and energy density measurement were also similarly performed. The composition and producing conditions of the positive electrode active material are shown in Table 2, and the measurement result is shown in Table 4.

TABLE 1

| | | Synthesis | Pre-calcining |
|---|---|---|---|
| | Composition | method | temperature (° C.) |
| Example 1-1 | LiFe_{0.2}Mn_{0.8}PO₄ | Solid phase | 440 |
| | | method | |
| Example 1-2 | LiFe_{0.2}Mn_{0.8}PO₄ | Solid phase | 600 |
| | | method | |
| Example 1-3 | LiMnPO₄ | Solid phase | 440 |
| | | method | |
| Example 1-4 | LiMnPO₄ | Solid phase | 600 |
| | | method | |
| Example 1-5 | LiFePO₄ | Solid phase | 440 |
| | | method | |
| Example 1-6 | LiFePO₄ | Solid phase | 600 |
| | | method | |
| Example 1-7 | LiMn_{0.77}Fe_{0.2} | Solid phase | 440 |
| | Mg_{0.03}PO₄ | method | |

TABLE 2

| | | Synthesis | Pre-calcining |
|---|---|---|---|
| | Composition | method | temperature (° C.) |
| Reference | LiFe_{0.2}Mn_{0.8}PO₄ | Solid phase | 380 |
| example1-1 | | method | |
| Comparative | LiFe_{0.2}Mn_{0.8}PO₄ | Hydrothermal | — |
| example 1-1 | | synthesis method | |
| Reference | LiMnPO₄ | Solid phase | 380 |
| example 1-2 | | method | |
| Comparative | LiMnPO₄ | Hydrothermal | — |
| example 1-2 | | synthesis method | |
| Reference | LiFePO₄ | Solid phase | 380 |
| example 1-3 | | method | |
| Comparative | LiFePO₄ | Hydrothermal | — |
| example 1-3 | | synthesis method | |

TABLE 3

| | | Actually | | | | | |
|---|---|---|---|---|---|---|---|
| | Average | measured | | | | | |
| | primary | value of | | Content of | | | |
| | particle | specific | | carbon | | Rate | Energy |
| | diameter | surface area | Roughness | (percent by | Capacity | characteristic | density |
| | (nm) | (m²/g) | factor | mass) | (Ah/kg) | (Ah/kg) | (Wh/kg) |
| Example 1-1 | 52 | 42 | 1.31 | 2.23 | 155 | 137 | 596 |
| Example 1-2 | 105 | 17 | 1.07 | 2.92 | 156 | 115 | 600 |
| Example 1-3 | 55 | 45 | 1.49 | 2.08 | 130 | 100 | 480 |
| Example 1-4 | 118 | 16 | 1.13 | 3.12 | 110 | 60 | 412 |
| Example 1-5 | 48 | 48 | 1.38 | 1.85 | 165 | 145 | 546 |
| Example 1-6 | 115 | 15 | 1.04 | 2.05 | 160 | 130 | 525 |
| Example 1-7 | 51 | 50 | 1.53 | 2.35 | 158 | 140 | 602 |

TABLE 4

| | | Actually | | | | | |
|---|---|---|---|---|---|---|---|
| | Average | measured | | | | | |
| | primary | value of | | Content of | | | |
| | particle | specific | | carbon | | Rate | Energy |
| | diameter | surface area | Roughness | (percent by | Capacity | characteristic | density |
| | (nm) | (m²/g) | factor | mass) | (Ah/kg) | (Ah/kg) | (Wh/kg) |
| Reference | 60 | 21 | 0.76 | 2.85 | 122 | 98 | 456 |
| example 1 | | | | | | | |
| Comparative | 110 | 14 | 0.92 | 3.22 | 135 | 101 | 486 |
| example 1 | | | | | | | |
| Reference | 75 | 17 | 0.77 | 2.99 | 100 | 43 | 369 |
| example 2 | | | | | | | |
| Comparative | 120 | 12 | 0.86 | 3.45 | 100 | 52 | 402 |
| example 2 | | | | | | | |
| Reference | 72 | 19 | 0.82 | 2.31 | 141 | 116 | 486 |
| example 3 | | | | | | | |
| Comparative | 113 | 14 | 0.95 | 2.89 | 150 | 123 | 505 |
| example 3 | | | | | | | |

The characteristics of the positive electrode active material having an olivine structure are varied depending on a mol ratio of Mn to Fe in M. Materials having a greater amount of Fe are generally excellent in the capacity and the rate characteristic. However, energy density is decreased because the average voltage is decreased. Therefore, the examples, the reference examples, and the comparative examples are compared with one another for the individual compositions of the positive electrode active materials.

When examples 1-1 and 1-2 in which the positive electrode active material is LiFe_{0.2}Mn_{0.8}PO₄ are compared with reference example 1-1 and comparative example 1-1, the examples are higher in all the three items, the capacity, the rate characteristic, and energy density than in the reference example and the comparative example.

Moreover, when examples 1-3 and 1-4 in which the positive electrode active material is LiMnPO₄ are compared with reference example 1-2 and comparative example 1-2, the examples are also higher in all the three items, the capacity, the rate characteristic, and energy density than in the comparative example.

Furthermore, when examples 1-5 and 1-6 in which the positive electrode active material is LiFePO₄ are compared with reference example 1-3 and comparative example 1-3, the examples are also higher in all the three items, the capacity, the rate characteristic, and energy density than in the comparative example.

In addition, example 1-7 in which Mg was added shows the improvement of energy density and the rate characteristic as compared with example 1 with no addition of Mg. There is a possibility that the addition of Mg improves crystallizability and causes an easy emission and occlusion of Li.

When the roughness factors of the examples, the reference examples, and the comparative examples are compared with one another, in all the examples, the roughness factor exceeds one, whereas in all the reference examples and the comparative examples, the roughness factor is not greater than one. When the particle diameter is in a sphere and completely dispersed, the roughness factor is one, which is increased or decreased because of a plurality of factors. A cause of an increase is an increase in the surface roughness of the particles. In the examples, the roughness factor is high because of the use of the producing method that increases the surface roughness of the particles. Moreover, in the examples, calcining at a crystallization temperature or greater prevents unreacted substances from being produced and keeps an excellent dispersed state even after main calcining, so that the specific surface area is high.

On the other hand, in reference examples 1-1 to 1-3, the pre-calcining temperature is lower than the crystallization temperature, and unreacted substances remain before main calcining. Thus, it is considered that the aggregation and sintering of particles occurred, the specific surface area and the roughness factor became small even though the particle diameter is small (17 to 21 μm), the reactivity of the positive electrode active material with the electrolyte was decreased, and the capacity, the rate characteristic, and energy density of the battery were decreased.

In comparative examples 1-1 to 1-3, the positive electrode active material is produced by a hydrothermal synthesis method, the surface of the particles is smooth, and the surface roughness is lower than in the examples. Thus, it is considered that the roughness factor became small, the reactivity of the positive electrode active material with the electrolyte was decreased, and the capacity, the rate characteristic, and energy density of the battery were decreased.

Also in comparison in FIGS. 3A to 3D, it is revealed that the surface roughness is greater in the positive electrode active material according to the present invention (FIGS. 3A and 3B) than in the previously existing positive electrode active material (FIGS. 3C and 3D).

From the result described above, it is shown that the positive electrode active material for lithium secondary batteries according to the present invention can provide a positive electrode active material for lithium secondary batteries that a highly safe polyanion compound is used, a capacity, a rate characteristic, and energy density higher than a lithium secondary battery using a previously existing polyanion positive electrode active material are achieved, and the smoothness and uniformity of the electrode are excellent.

### Example 2

In example 1, the positive electrode active material in the primary particle form will be described. The positive electrode active material is often used in the form of secondary particles because of easy preparation of electrodes and the like. In the following, example 2 will describe a method for producing a positive electrode active material formed in secondary particles and measurement results of the characteristics (the capacity and the rate characteristic) of electrodes prepared using the produced positive electrode active material. More specifically, the relationship between secondary particle diameters and corresponding electrodes will be described.

### [Method for Producing a Positive Electrode Active Material]

In the following, a method for producing a positive electrode active material according to the present invention will be described.

FIG. 5 is a producing flow.
Step S100: mix raw materials of the positive electrode active material.
Step S200: pre-calcine the mixed raw materials to obtain a pre-calcined body.
Step S300: mix the pre-calcined body with a carbon source.
Step S400: form slurry including the mixed carbon source into secondary particles.
Step S500: subject the mixed pre-calcined body and the carbon source to main calcining.

It is noted that the detail of processes in the steps will be described below in order.

### Example 2-1

### (i) Mixing Raw Materials

The materials and specifications similar to the preparation of a lithium secondary battery according to example 1-1 described above.

### (ii) Pre-Calcining

Raw material powder was pre-calcined using a box electric furnace. The calcining atmosphere was air, the calcining temperature was 440° C., and calcining hours were ten hours.

### (iii) Mixing and Covering a Carbon Source

Sucrose in an amount of 7 percent by mass was added as a carbon source and a particle diameter control agent to the pre-calcined body. They were crushed and mixed for two hours using a ball mill.

### (iv) Formation of Secondary Particles

In the ball mill process, pure water was used for a dispersion medium. After mixing using the ball mill, slurry was sprayed and dried at an air spray pressure of 0.2 MPa using a spray dryer having four hydraulic nozzles for forming secondary particles.

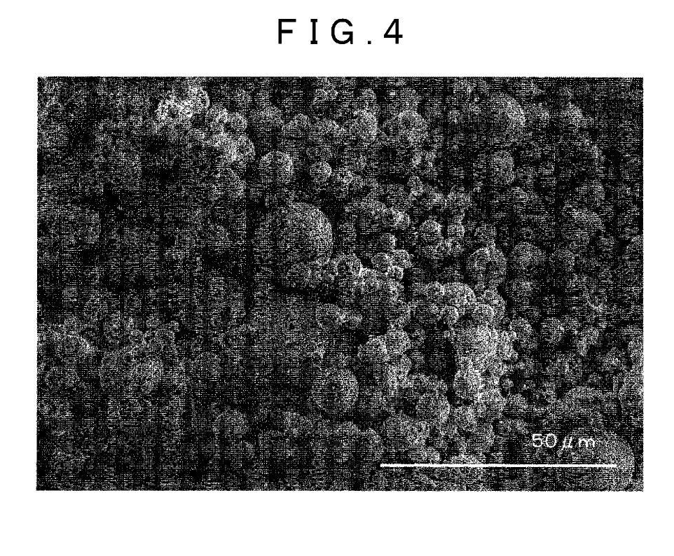

It is noted that the slurry prepared in the steps of mixing and covering carbon is sprayed and dried using a spray dryer, and spherical secondary particles in average secondary particle diameters of 5 to 20 μm are prepared. FIG. 4 is an SEM photograph of exemplary spherical secondary particles according to the present invention.

It is noted that spraying and drying are methods for obtaining spherical particles in which slurry in fine particles is supplied to a drying chamber and dried. When the average particle size of the spherical secondary particles is less than 5 μm, there is tendency that the packing density becomes low in forming an electrode. When the average particle size exceeds 20 μm, the secondary particles become large with respect to the thickness of the electrode, and the density of the electrode is decreased. It is noted that the density of the electrode is calculated by dividing the coating amount (mg/cm²) by the thickness of the electrode (μm).

### (v) Main Calcining

Subsequently, main calcining was performed using a tubular furnace that was enabled to control atmospheres. The calcining atmosphere was an Ar atmosphere, the calcining temperature was 700° C., and calcining hours were ten hours. In the steps described above, olivine LiFe_{0.2}Mn_{0.8}PO₄ was obtained.

### [Method for Preparing a Positive Electrode]

An electrode (a positive electrode) was prepared using the produced active material, and the characteristics of the electrode, that is, the capacity and the rate characteristic were measured. The method for preparing the electrode is similar to the method described in example 1 mentioned above.

### [Measurement and Evaluation of the Positive Electrode]

The measurement tests of the capacity and the rate characteristics were performed in an Ar atmosphere. In the measurement of the capacity, constant current charge was performed up to a voltage of 4.5 V at a current value of 0.1 mA to the model cell, and constant voltage charge was performed until the current value was attenuated to 0.03 mA after reaching a voltage of 4.5 V. After that, the model cell was discharged at a constant current of 0.1 mA up to a voltage of 2 V, and a discharge capacity at this time was defined as a capacity. The capacity was calculated per weight and per volume of the positive electrode active material.

After the charging and discharging cycle described above was repeated for three cycles, and the rate characteristic was evaluated under the conditions below. Similarly to capacity measurement, a capacity when the model cell subjected to constant current charge and constant voltage charge was subjected to constant current discharge at a current value of 5 mA was defined as a rate characteristic. It is noted that all the tests were performed at an ambient temperature (25° C.)

It is noted that the conditions used for evaluating materials and the like are as follows.

(a) Average Primary Particle Diameter Evaluation

The diameter was evaluated according to XRD measurement similar to the method described in example 1 mentioned above.

(b) Specific Surface Area Measurement (Roughness Factor Evaluation)

The specific surface area was evaluated by a similar method described in example 1 mentioned above. It is noted that in the measurement of the specific surface area of the active material particles, particles that the coating was removed from the surface were used. Although a removal method is not limited, the shape of the particle surface does not have to be changed. For example, in the case of the carbon coating, the particles are heated at a temperature of 450° C. in an air atmosphere for one hour, so that the carbon coating can be removed with no influence on the shape of the particle surface.

(c) Charging and Discharging Test (Capacity Evaluation)

The model cell was evaluated by a similar method described in example 1 mentioned above.

(d) Average Secondary Particle Diameter Evaluation

The average particle diameter was measured using a laser diffraction particle size analyzer (LA-920 made by HORIBA, Ltd.).

### Example 2-2

LiFe_{0.2}Mn_{0.8}PO₄ was obtained by being produced as similar to example 2-1 except that the pre-calcining temperature was 600° C. The capacity and the rate characteristic were also similarly measured.

### Example 2-3

Sucrose in an amount of 7 parts by weight was added as a carbon source and a particle diameter control agent to the pre-calcined body in 100 parts by weight, and they were crushed and mixed for two hours using a ball mill. After mixing using the ball mill, LiFe_{0.2}Mn_{0.8}PO₄ was obtained by being produced as similar to example 2-1 except that the slurry was dried using an evaporator. The capacity and the rate characteristic were also similarly measured.

### Comparative Example 2-1

LiFe_{0.2}Mn_{0.8}PO₄ was obtained by being produced as similar to example 2-1 except that the pre-calcining temperature was 380° C. The capacity and the rate characteristic were also similarly measured.

### Comparative Example 2-2

A hydrothermal synthesis method was performed. Lithium hydroxide, phosphoric acid, sulfuric acid manganese, sulfuric acid iron were used for raw materials, and the raw materials were measured in a mol ratio of Li:PO₄:Mn:Fe=3:1:0.8:0.2. A lithium hydroxide aqueous solution was dropped in a solution that sulfuric acid manganese, sulfuric acid iron, and phosphoric acid were dissolved in pure water while stirring the solution, and a suspension including precipitation was obtained. The obtained suspension was subjected to nitrogen bubbling, and sealed in a pressure container while purging nitrogen. The pressure container was heated at a temperature of 170° C. for five hours while rotated and stirred, the obtained precipitation was filtered and cleaned, and then LiMn_{0.8}Fe_{0.2}PO₄ was obtained.

Slurry was prepared from the material using a wet ball mill, and sprayed and dried at an air spray pressure of 0.2 MPa using a spray dryer having four hydraulic nozzles for forming secondary particles.

In the steps described above, carbon coated LiFe_{0.2}Mn_{0.8}PO₄ was obtained. The capacity and the rate characteristic were measured by a method similar to example 2-1.

### Example 2-4

LiFe_{0.2}Mn_{0.8}PO₄ was obtained by being produced as similar to example 2-1 except that the air spray pressure was 1.0 MPa. The capacity and the rate characteristic were also similarly measured.

### Example 2-5

LiFe_{0.2}Mn_{0.8}PO₄ was obtained by being produced as similar to Example 2-1 except that a disk spray dryer was used for drying slurry after mixing using the ball mill. The capacity and the rate characteristic were also similarly measured.

### [Comparison of Measurement Results]

For examples 2-1 to 2-5 and comparative examples 2-1 and 2-2 described above, Table 5 shows the particle diameter of the primary particle, the specific surface area, the roughness factor, the shape of the secondary particles, and the average particle diameter, the density of the electrode, the capacity, and the rate characteristic of the secondary particles of LiFe_{0.2}Mn_{0.8}PO₄ obtained by main calcining.

TABLE 5

| | Average | Specific | Roughness | Secondary | Average | Electrode | | | Rate |
|---|---|---|---|---|---|---|---|---|---|
| | primary | surface | factor of | Particle | secondary | density | Capacity | Capacity | characteristic |
| | particle | area | primary | Shape | particle | (g/cm³) | (Ah/kg) | (mAh/cc) | (Ah/kg) |
| Example 2-1 | 52 | 42 | 1.31 | spherical | 12 | 1.83 | 156 | 285 | 142 |
| | | | | shape | | | | | |
| Example 2-2 | 95 | 19 | 1.05 | spherical | 13 | 1.82 | 152 | 277 | 140 |
| | | | | shape | | | | | |
| comparative | 60 | 17 | 0.77 | spherical | 15 | 1.79 | 100 | 179 | 43 |
| example 2-1 | | | | shape | | | | | |
| comparative | 110 | 14 | 0.92 | spherical | 13 | 1.8 | 135 | 243 | 101 |
| example 2-2 | | | | shape | | | | | |
| Example 2-3 | 52 | 42 | 1.31 | spherical | 3 | 1.63 | 153 | 249 | 141 |
| | | | | shape | | | | | |
| Example 2-4 | 52 | 42 | 1.31 | spherical | 25 | 1.68 | 155 | 260 | 144 |
| | | | | shape | | | | | |
| Example 2-5 | 52 | 42 | 1.31 | amorphous | — | 1.45 | 155 | 228 | 137 |
| | | | | shape | | | | | |

When examples 2-1 and 2-2 are compared with comparative examples 2-1 and 2-2, in examples 2-1 and 2-2, the capacity values (Ah/kg) per weight are 156 and 152, respectively. On the other hand, in comparative examples 2-1 and 2-2, the capacity values (Ah/kg) per weight are 100 and 135, respectively. It is revealed that the capacity is higher in the examples than in the comparative examples. Moreover, it is revealed that the capacity value (mAh/cc) per volume also has a similar tendency.

Furthermore, it is revealed from Table 5 that the rate characteristic is also higher in examples 2-1 and 2-2 than in comparative examples 2-1 and 2-2. Therefore, it is revealed that both of the capacity and the rate characteristic are higher in the examples than in the comparative examples and the rate characteristic is high more specifically.

For the powder characteristics of the primary particles, when examples 2-1 and 2-2 are compared with comparative examples 2-1 and 2-2 on the roughness factor of the primary particles, the roughness factor exceeds one in all in the examples, whereas the roughness factor is not greater than one in all the comparative examples.

When the particles are in a sphere and completely dispersed, the roughness factor of the primary particles is one, which is increased or decreased because of a plurality of factors. A cause of an increase is an increase in the surface roughness of the particles. In the examples, since a producing method that increases the surface of the particles roughness is used, the roughness factor of the primary particles is high. On the other hand, in the comparative examples, since the surface of the particles is smooth, the roughness factor of the primary particles is lower than that of the examples.

Moreover, when the aggregation and sintering of the particles occur, the roughness factor of the primary particles is decreased. In comparative example 2-1, since the pre-calcining temperature is lower than the crystallization temperature and unreacted substances remain before main calcining, it is considered that the aggregation and sintering of particles occur, the specific surface area is low even though the particle diameter looks small, and the activity is decreased.

In comparative example 2-2, the material is prepared by a hydrothermal synthesis method, the particles have a smooth surface, and the roughness factor of the primary particles is decreased. In other words, it is considered that when the particles have the same particle diameter, the specific surface area is low and the activity is decreased. On the other hand, in the examples, calcining at a crystallization temperature or greater prevents unreacted substances from being produced and keeps an excellent dispersed state even after main calcining, so that the specific surface area is high. In other words, it is revealed that the roughness factor of the primary particles determined from the values of the particle diameter and the specific surface area greatly affects the characteristics.

When example 2-1 is compared with examples 2-3 and 2-4, the average particle diameter of the secondary particles is 12 μm in example 2-1, the average particle diameter of the secondary particles is 3 μm in example 2-3, and the average particle diameter of the secondary particles is 25 μm in example 2-4. Therefore, in the relationship between the particle diameter and the electrical characteristics, the capacity (mAh/cc) per volume is 285 in example 2-1, whereas the capacity (mAh/cc) per volume is 249 and 260 in low values in examples 2-3 and 2-4.

Moreover, also for the density of the electrode (g/cm³), the density is 1.83 in example 2-1, whereas the density is 1.63 and 1.68 in low values in examples 2-3 and 2-4, respectively.

In other words, it is revealed that the average secondary particle diameter affects the density of the electrode and the capacity per volume. It is revealed that when the average secondary particle diameter is less than 5 μm and exceeds 20 μm, the density of the electrode is decreased, and the capacity per volume of the positive electrode active material is decreased.

Example 2-1 is different from example 2-3 in that sucrose in an amount of 7 parts by weight is added as a carbon source and a particle diameter control agent to the pre-calcined body in 100 parts by weight and they are mixed using the ball mill, and then slurry is dried using a spray dryer for obtaining the secondary particles in example 2-1, or the slurry is dried using an evaporator for obtaining the secondary particles in example 2-3.

When example 2-1 is compared with example 2-5, as for the shape of the positive electrode active material, the spherical secondary particles were obtained in example 2-1, whereas amorphous secondary particles were obtained in example 2-5.

Subsequently, when the density of the electrode, the capacity per volume, and the rate characteristic in example 2-1 are observed, they are 1.83, 285, and 142, respectively. On the other hand, in example 2-5, they are 1.45, 228, and 137, respectively. Thus, as a result, all of the density of the electrode, the capacity per volume, and the rate characteristic are higher in example 2-1. The spherical secondary particles are formed by spray-drying, the density of the electrode is improved. On the other hand, in secondary particles not formed by spray-drying, the density of the electrode is not easily improved. The secondary particles formed by spray-drying also had excellent electrode characteristics.

In the case where primary particles are dried using a spray dryer, since slurry droplets in which primary particles are dispersed are instantaneously dried by a hot blast, such secondary particles can be obtained in which primary particles are densely packed. It is considered that in the secondary particles in which primary particles are densely packed whose roughness factor of the primary particles exceeds one, the contact points between the primary particles are increased, the resistance between the primary particles is decreased, and the rate characteristic is improved.

As described above, according to the examples, a positive electrode was obtained, which had the characteristics that the density of the electrode of the positive electrode was 1.8 g/cm³ or greater, the capacity value per weight was 150 Ah/kg or greater, and the rate characteristic was 140 Ah/kg or greater.

### LIST OF REFERENCE SIGNS

1 Battery cover
2 Gasket
3 Positive electrode lead
4 Insulating plate
5 Battery container
6 Negative electrode
7 Separator
8 Insulating plate
9 Negative electrode lead
10 Positive electrode

1.-15. (canceled)

16. A positive electrode active material for lithium secondary batteries comprising:
a polyanion compound particle coated with carbon, wherein
the polyanion compound is expressed by the following chemical formula LixMAyOz (chemical formula 1) and is an olivine compound including at least Fe,
a roughness factor of the polyanion compound is in a range of 1 to 2,
an average primary particle diameter of the polyanion compound is in a range of 10 to 150 nm,
where in chemical formula 1
M includes at least one kind of a transition metallic element,
A is a main group element that is bonded to oxygen O and that forms an anion,
0<x≦2, 1≦y≦2, and 3≦z≦7),
the roughness factor is expressed by the following equation (equation 1)=specific surface area (a) measured using a BET method/specific surface area (b) calculated from an average primary particle diameter, and
the average primary particle is spherical.

17. The positive electrode active material for lithium secondary batteries according to claim 16,
wherein the polyanion compound has an olivine structure expressed by the following chemical formula LiMPO₄ (chemical formula 2), where M is at least one kind of Fe, Mn, Co, and Ni.

18. The positive electrode active material for lithium secondary batteries according to claim 17,
wherein M in the polyanion compound having an olivine structure includes Mn and Fe; and
a ratio of Fe occupied in M is greater than 0 mol % and not greater than 50 mol % in a mol ratio.

19. The positive electrode active material for lithium secondary batteries according to claim 16,
wherein a content of the carbon ranges from 2 to 5 percent by mass.

20. The positive electrode active material for lithium secondary batteries according to claim 17,
wherein a content of the carbon ranges from 2 to 5 percent by mass.

21. The positive electrode active material for lithium secondary batteries according to claim 18,
wherein a content of the carbon ranges from 2 to 5 percent by mass.

22. The positive electrode active material for lithium secondary batteries according to claim 16,
wherein an average particle diameter of the primary particles is 10 nm or greater and 100 nm or less.

23. The positive electrode active material for lithium secondary batteries according to claim 16,
wherein the positive electrode active material is formed of secondary particles, to which a plurality of primary particles are aggregated.

24. The positive electrode active material for lithium secondary batteries according to claim 23,
wherein an average particle diameter of the secondary particle diameter ranges from 5 to 20 μm.

25. A positive electrode for lithium secondary batteries comprising:
a positive electrode mixture including a positive electrode active material; and
a positive electrode current collector, wherein
the positive electrode active material is any one of the positive electrode active materials for lithium secondary batteries according to claim 16.

26. A positive electrode for lithium secondary batteries comprising:
a positive electrode mixture including a positive electrode active material; and
a positive electrode current collector, wherein
the positive electrode active material is any one of the positive electrode active materials for lithium secondary batteries according to claim 17.

27. A positive electrode for lithium secondary batteries comprising:
a positive electrode mixture including a positive electrode active material; and
a positive electrode current collector, wherein
the positive electrode active material is any one of the positive electrode active materials for lithium secondary batteries according to claim 18.

28. A positive electrode for lithium secondary batteries comprising:
a positive electrode mixture including a positive electrode active material; and
a positive electrode current collector, wherein
the positive electrode active material is any one of the positive electrode active materials for lithium secondary batteries according to claim 22.

29. A positive electrode for lithium secondary batteries comprising:
a positive electrode mixture including a positive electrode active material; and
a positive electrode current collector, wherein
the positive electrode active material is any one of the positive electrode active materials for lithium secondary batteries according to claim 23.

30. A positive electrode for lithium secondary batteries comprising:
a positive electrode mixture including a positive electrode active material; and
a positive electrode current collector, wherein
the positive electrode active material is any one of the positive electrode active materials for lithium secondary batteries according to claim 24.

31. A lithium secondary battery comprising;
a positive electrode;
a negative electrode;
a separator that partitions the positive electrode from the negative electrode; and
an electrolyte, wherein
the positive electrode is the positive electrode for lithium secondary batteries according to calm 25.

32. The lithium secondary battery according to claim 31,
wherein an electrode density of the positive electrode is 1.8 g/cm³ or greater, a capacity value per weight is 150 Ah/kg or greater, and a rate characteristic is 140 Ah/kg or greater.

33. A method for producing a positive electrode active material for lithium secondary batteries expressed by chemical formula LiMPO₄ (where M includes at least one of Fe, Mn, Co, and Ni) and having an olivine compound including at least Fe, the method comprising the steps of:
mixing a transition metal compound to be a metal source with a phosphorus compound;
pre-calcining the mixed raw materials in an oxidizing atmosphere;
mixing a pre-calcined body obtained in the step of pre-calcining with a carbon source; and
subjecting the pre-calcined body mixed with the carbon source to main calcining in a reducing atmosphere, wherein
a pre-calcining temperature in the step of pre-calcining is a crystallization temperature of the positive electrode active material or greater and a temperature that the crystallization temperature is added with a temperature of 200° C. or less.

34. The method for producing a positive electrode active material for lithium secondary batteries according to claim 33,
wherein after the step of pre-calcining and before the step of main calcining, the step of forming the pre-calcined body into secondary particles is included.

35. The method for producing a positive electrode active material for lithium secondary batteries according to claim 33,
wherein a pre-calcining temperature in the step of pre-calcining ranges from a temperature of 420° C. to a temperature of 600° C.

36. The method for producing a positive electrode active material for lithium secondary batteries according to claim 33,
wherein a main calcining temperature in the step of main calcining ranges from a temperature of 600° C. to a temperature of 850° C.

37. The method for producing a positive electrode active material for lithium secondary batteries according to claim 33,
wherein the step of pre-calcining and the step of main calcining are a solid phase method.
